(19) United States
(12) Patent Application Publication
(10) Pub. No.: US 2020/0294079 A1
(43) Pub. Date: Sep. 17, 2020

(54) METHOD AND APPARATUS FOR CALCULATING PROMOTION ADJUSTED LOYALTY

(71) Applicant: Walmart Apollo, LLC, Bentonville, AR (US)

(72) Inventor: Diptarka Saha, Bangalore (IN)

(21) Appl. No.: 16/406,231

(22) Filed: May 8, 2019

(30) Foreign Application Priority Data
Feb. 21, 2019 (IN) 201911006804

(51) Int. Cl. G06Q 30/02; G06Q 30/06

(52) U.S. Cl. CPC G06Q 30/0238; G06Q 30/0633; G06Q 30/0226

(57) ABSTRACT

Systems and methods for determining promotional adjusted customer loyalty to items sold at a facility are discussed. Embodiments enable the automatic re-ordering of items for a facility based on adjusted loyalty values.

### RELATED APPLICATION

This application claims priority to Indian Patent Application No. 201911006804, filed on Feb. 21, 2019, the contents of which are incorporated herein by reference in their entirety.

### BACKGROUND

Retail decisions on how much of an item to keep in inventory are frequently made based on past and/or anticipated future sales data. One factor influencing purchasing decisions for an item is the amount of loyalty to the item exhibited by customers as items to which customers are loyal tend to generate more dependable sales. Accordingly a consumer's loyalty to an item is an important component used in making product purchasing decisions regarding how much of an item to stock an item at a retail facility.

### BRIEF SUMMARY

In one embodiment, a system for determining promotion adjusted loyalty includes at least one Point of Sale (PoS) terminal configured to process a current transaction in a facility that includes at least one item. The processing generates transaction data that is associated with a customer and includes a promotional status for the at least one item during the current transaction. The system also includes an inventory ordering module that when executed programmatically submits an order for one or more items to be delivered to the facility. The system further includes a server in communication with the at least one PoS terminal, the server configured to store the current transaction data relating to the at least one item and previous transaction data received from the PoS terminal relating to previous transactions that include the at least one item. The previous transaction data is associated with a customer and includes a promotional status for the at least one item during each of the previous transactions. The system further includes a computing device configured to execute a loyalty determination module. The loyalty determination module, when executed, determines an initial loyalty value of the customer for the at least one item using the stored current transaction data and previous transaction data and generates a promotion adjusted loyalty value of the customer for the at least one item using the initial loyalty value and at least one promotion metric. The loyalty determination module when executed further generates programmatically an inventory order for the at least one item via the inventory ordering module based on the promotion adjusted loyalty value of the customer and promotion adjusted loyalty values of other customers.

In another embodiment, a computing device-implemented method for determining promotion adjusted loyalty includes receiving and storing current transaction data and previous transaction data from at least one Point of Sale (PoS) terminal in a facility. The current transaction data is related to a current transaction in the facility that includes at least one item. The current transaction data is also associated with a customer and includes a promotional status for the at least one item during the current transaction. The previous transaction data relates to a previous transaction by the customer that are related to the at least one item and includes a promotional status for the at least one item during each of the previous transactions. The method also determines an initial loyalty value of the customer for the at least one item using the stored current transaction data and previous transaction data. Additionally the method generates a promotion adjusted loyalty value of the customer for the at least one item using the initial loyalty value and at least one promotion metric. The method also generates programmatically an inventory order for the at least one item via an inventory ordering module based on the promotion adjusted loyalty value of the customer and promotion adjusted loyalty values of a plurality of other customers meeting a pre-defined threshold. The inventory ordering module programmatically submits an order for one or more items to be delivered to the facility.

### BRIEF DESCRIPTION OF THE DRAWINGS

The accompanying drawings, which are incorporated in and constitute a part of this specification, illustrate one or more embodiments of the invention and, together with the description, help to explain the invention. The drawings are not necessarily to scale, or inclusive of all elements of a system, emphasis instead generally being placed upon illustrating the concepts, structures, and techniques sought to be protected herein. In the drawings:

FIG. 1 is a block diagram of a system for determining promotion adjusted loyalty, according to an example embodiment.

FIG. 2 is a high-level flow diagram for a method of determining promotion adjusted loyalty, according to an example embodiment.

FIG. 3 is a diagram of an exemplary network environment suitable for implementing capacity modification for a new facility according to an exemplary embodiment.

FIG. 4 is a block diagram of an exemplary computing device that may be used to implement exemplary embodiments described herein.

### DETAILED DESCRIPTION

Embodiments of the present invention leverage customer transaction data to determine how much of a customer's loyalty to an item offered for sale in retail facilities (as expressed through purchase data) is attributable to promotional offers. As described further herein, embodiments first determine an initial loyalty value for a customer and then adjust that value using a variety of mechanisms to determine an adjusted loyalty value of the customer for the item. The adjusted loyalty value of the customer and other customers may be used to programmatically determine how much inventory to stock/order for a retail facility.

The customer transaction data used by embodiments may be gathered in a number of ways that address and mitigate potential privacy concerns. For example transaction data may be gathered using techniques such as a mobile app identifying the customer to the POS (e.g. when the customer registers the app an ID is assigned to the customer and that ID is provided to the POS device with each interaction between the customer's device and the POS). Transaction data may also be gathered from online orders where the customer supplies their name or the customer swiping a loyalty card at the POS if they don't have a smartphone. It will be appreciated that the use of the app/loyalty card or the use of an online ordering system may require the customer to opt-in to letting the facility track their transactions as part of the registration process before any transaction data is saved for the customer.

In one embodiment, for a particular item, a promotion adjusted loyalty value is determined for each customer/household (HH) from the customer's/HH's past purchases as a function of exponentially weighted average of the past purchases along with penalties and rewards that reflect the effect of a promotion. For ease of explanation herein some descriptive examples will be made referencing only households. Such description of households should be understood to also encompass situations where an individual customer makes up the household.

In one example embodiment the suffixes h,j,t denote household ID, product ID, and visit number respectively and the following definitions apply:

Transaction (T): The random variable transaction is defined as Tₕ(t)=j if HH h bought the product j at visit number t.

Promotion (P): This is an indicator variable that defines whether a transaction was made under promotion or not. So, for a transaction Tₕ=j

$$P ( T ) = \{ \begin{matrix}1 , j was on promotion during t visit t of HH h \\ 0 , j {wasn}^{′} t on promotion during visit t of HH h\end{matrix}$$

Promotion Delta (ΔP): This is another categorical variable that takes value 1 if the HH's last transaction was not under promotion but the current one is and vice versa. Formally,

ΔP(T)=P(Tₕ(t))−P(Tₕ(t−1))

Switch (S): This variable denotes if a transaction is different from the one before it.

$$S ( T ) = \{ \begin{matrix}1 , {T}_{h} ( t ) \neq {T}_{h} ( t - 1 ) \\ 0 , {T}_{h} ( t ) = {T}_{h} ( t - 1 )\end{matrix}$$

Loyal HH: A household is said to be a loyalty HH if they buy the same product in every visit.

Tₕ(t)=j ∀t for some j ∈ [symbol] Let [symbol] ⊆ [symbol] denote the set of all the loyal HHs.

Also define, [symbol] ⱼ ⊆ [symbol] as [symbol] ⱼ={h ∈ [symbol] |h ∈ Uₜ Tₕ(t)}

In one embodiment loyalty proportion can be expressed by the following relationship:

$${Y}_{ij} ( t ) = \{ \begin{matrix}1 , & if {h}^{th} HH bought item j at visit t \\ 0 , & else\end{matrix}$$

However, given this definition one still must measure if a HH was persuaded by promotion to make a purchase. One possible way to measure if a household (HH) is persuaded by a promotion into buying a product is by way of the equation:

β(i)=proportion of transactions of product i under promotion.

However, it should be understood that the above equation is a very aggregated variable that doesn't provide information about the propensity of the HH to change preference and therefore it doesn't aid in determining if a HH will switch preference if the product was under promotion.

Accordingly, in order to account for this, in one embodiment the random variable transaction is defined by:

Tₕ(t)=i if HH h bought the product at visit number t.

This is essentially denoting that the household h bought the product i at visit number t.

For a transaction T:

$$P ( T ) = \{ \begin{matrix}1 , j was on promotion during t visit t of HH h \\ 0 , j {wasn}^{′} t on promotion during visit t of HH h\end{matrix}$$

This denotes the transaction T was done under promotion. Then:

ΔP(T)=P(Tₕ(t))−P(Tₕ(t−1))

This variable will be 1 if the HH's last transaction was not under promotion but the current one is and vice versa. Finally:

$$S ( T ) = \{ \begin{matrix}1 , & {T}_{h} ( t ) \neq {T}_{h} ( t - 1 ) \\ 0 , & {T}_{h} ( t ) = {T}_{h} ( t - 1 )\end{matrix}$$

This denotes if a transaction is different from the one before it. Under these notations, the previous statistic leads to a promotion metric β wherein the number of purchases of an item under promotion divided by the number of purchases of the item:

$$β ( j ) = \frac{Σ I ( T = j ⋂ P ( T ) = 1 )}{Σ I ( T = j )}$$

Where, I denotes the indicator function defined by:

$$I ( A ) = \{ \begin{matrix}1 & A true \\ 0 & else\end{matrix}$$

When this value is high, then the sale of product i is primarily driven through promotion and all such transactions should be penalized while calculating loyalty. For example, if the total number of items sold under promotion were 469,402 and the total number of items sold were 862,080 then β would be 0.5445

With the same notations, another promotion metric is Γ which defines the proportion of switches to product i in which ΔP−1, i.e. among all the transactions where a HH switched to product i, what proportion was due to introduction of promotion:

$$γ ( j ) = \frac{Σ I ( T = j ⋂ S ( T ) = 1 ⋂ Δ P ( T ) = 1 )}{Σ I ( T = i ⋂ S ( T ) = 1 )}$$

When this value is high, then the sale of product i is primarily driven through promotion and all such transactions should be penalized while calculating loyalty. For example, if a total number of switches by a household to an item during a promotion were 3,737 and a total number of switches to the item were 11,231 then the metric would be 0.3327.

Another promotion metric ω can be defined as the proportion of transactions where HH did not switch from product i in which ΔP=−1, i.e. among all the transactions where a HH did not switch from product i, what was the proportion where promotion was withdrawn:

$$ω ( i ) = \frac{Σ I ( T = i ⋂ S ( T ) = 0 ⋂ Δ P ( T ) = - 1 )}{Σ I ( T = i ⋂ S ( T ) = 0 )}$$

When this value is high, even though the HH started buying the product i for the promotion, they didn't switch back even when the promotion was withdrawn thereby demonstrating loyalty to the product, and all such transactions should be rewarded while calculating loyalty. For example, if the number of times a HH did not switch from the item even after the promotion was stopped is 4.137 and the total number of times the HH bought the item was 223.894 then the metric would be 0.0185.

In some embodiments, the three metrics can be used individually or in combination for each product to measure the compound effect of promotion on sale and loyalty. These metrics can be used to provide a promotion adjusted loyalty value.

For example, in one embodiment, to account for possible effects of promotion, the definitions may be extended to include penalties and rewards for each transaction as set forth below:

The subscripts h,j,t denote households, alternative products, and time respectively.

To define Loyalty Proportion for a HH the following indicator variables are used:

$${Y}_{h j} ( t ) = \{ \begin{matrix}1 , & {T}_{h} ( t ) = j \\ 0 , & else\end{matrix} \\ {Z}_{h j} ( t ) = \{ \begin{matrix}1 , & {T}_{h} ( t ) = j and P ( T ) = 1 \\ 0 , & else\end{matrix} \\ {U}_{h j} ( t ) = \{ \begin{matrix}1 , & {T}_{h} ( t ) = j and ( T ) = 1 and Δ P ( T ) = 1 \\ 0 , & else\end{matrix} \\ {W}_{h j} ( t ) = \{ \begin{matrix}1 , & {T}_{h} ( t ) = j and S ( T ) = 0 and Δ P ( T ) = - 1 \\ 0 , & else\end{matrix}$$

Now define for some α ∈ (0,1), Loyⱼₕ¹(t)=α Loyⱼₕ¹(t−1)+(1−α) Yᵢⱼ(t)

And a more general version of this using the promotional information as

Loyⱼₕ²(t)=α Loyⱼₕ²(t−1)+(1−α) Yᵢⱼ(t)−β Zᵢⱼ(t)−γ Uᵢⱼ(t)+ω Wᵢⱼ(t)

Where,

$$α ∈ ( 0 , 1 ) , β = \frac{1}{n} {Σ}_{j} β ( j ) , γ = \frac{1}{n} {Σ}_{j} γ ( j ) , ω = \frac{1}{n} {Σ}_{j} ω ( j )$$

The variable Loyⱼₕ¹(t), henceforth called loyalty index, is used herein as a descriptive statistic that captures the bias of each household towards a particular product against its alternatives.

The variable Loyⱼₕ²(t) adds to this index by penalizing purchases made under promotion and rewarding purchases made without promotion and hence eliminates the effect of promotion while calculating the aforementioned bias. Loy¹ and Loy² act as backbones of ψ, ψ₂ respectively. Once the loyalty indices for each household/product at each time point are determined loyalty proportion for the household is defined.

Mₕ¹(t)=argmaxⱼ (Loyⱼₕ¹(t))

Mₕ²(t)=argmaxⱼ (Loyⱼₕ²(t))

then at that instant HH h is most biased towards j, since these values are dependent f for a household over time, the long run frequency of these is a good proxy for the overall bias towards a particular product against its alternatives.

Next define:

$${p}_{h}^{1} ( j ) = \frac{1}{{t}_{h}} {Σ}_{t} I ( {M}_{h}^{1} ( t ) = j )$$

$${p}_{h}^{2} ( j ) = \frac{1}{{t}_{h}} {Σ}_{r} I ( {M}_{h}^{2} ( t ) = j )$$

pₕ¹(j), pₕ²(j) serves as the loyalty proportion for the household, in the sense if the loyalty of a household is a constant number this is the share for each product.

Finally, pₕ¹(j), pₕ²(j) is summarized across households as follows:

$${ψ}_{1} ( j ) = \frac{{Σ}_{j} {p}_{h}^{1} ( j ) I ( {p}_{h}^{1} ( j ) > 0 )}{{Σ}_{h} I ( {p}_{h}^{1} ( j ) > 0 )} \\ {ψ}_{2} ( j ) = \frac{{Σ}_{j} {p}_{h}^{2} ( j ) I ( {p}_{h}^{2} ( j ) > 0 )}{{Σ}_{h} I ( {p}_{h}^{2} ( j ) > 0 )}$$

It should be noted that, if pₕ(j)=0 for some j, h, household h is not considered for calculating loyalty for the product j. This is due to the fact that generally | [symbol] |=n»tₕ and hence most of the entries in pₕ will be zero—so it will be ambiguous to consider these “disloyal” households while calculating loyalty as they will change the measure by huge margin and the measures will have no meaning.

This new loyalty measure (ψ₂) is corrected for promotion. An example of this correction may be seen in the chart below of the buying patterns of a HH:

| Item | A | A | B | B | B | A |
|---|---|---|---|---|---|---|
| Promotion index | 0 | 0 | 1 | 1 | 0 | 0 |
| Δ P | — | 0 | 1 | 0 | −1 | −1 |
| Z | 0 | 0 | 1 | 1 | 0 | 0 |
| W | — | 0 | 1 | 0 | 0 | 0 |
| U | — | 0 | 0 | 0 | 1 | 0 |

These results indicate that most of B-s purchases were a result of promotional activity, however—it also shows some new-born loyalty to B at visit number 5 where the HH continued with B even when the promotion was taken away. The loyalty numbers for this HH are:

| | |
|---|---|
| Market-Share (A) = ½ | Loyalty (A) = ⅔ |
| Market-Share (B) = ½ | Loyalty (B) = ⅓ |

Accordingly it can be seen that most of B's sales were due to promotions.

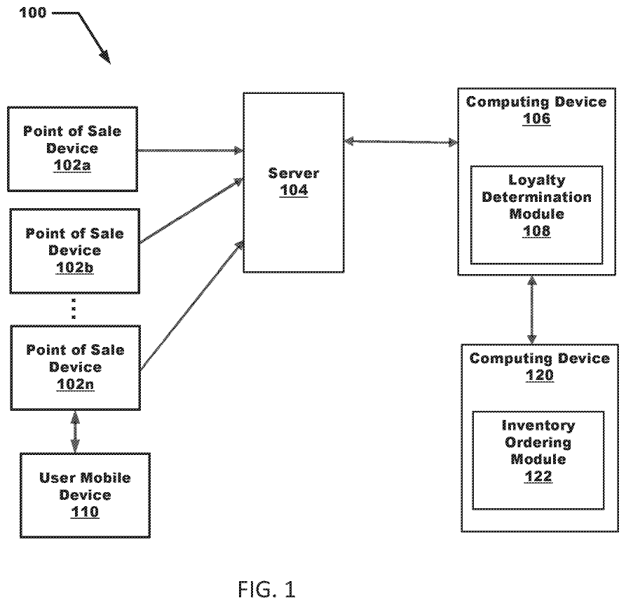

FIG. 1 is a block diagram of a system for determining promotion adjusted loyalty, according to an example embodiment. Referring to FIG. 1, a system 100 is shown for determining promotion adjusted loyalty. The system 100 can include one or more Point of Sale devices 102a-102n in a facility. Also shown is a customer mobile device 110 in communication with a PoS device. The customer mobile device may be used to complete a transaction with a PoS device and may provide identification information enabling the PoS device to identify a customer/HH. The system 100 further includes a server in communication with the PoS devices. The server is configured to receive and store current (and to have received previous transaction data) from the PoS devices 102a-102n that relates to at least one item being purchased in the facility (e.g. data for a particular item being sold). The current and previous transaction data includes a promotion status of the at least one item at the times of the respective transactions. For example, in one embodiment, the transaction data may be stored in a database and the data for each item may be represented as follows by recording the UPC code as an item identifier, each household/customer being assigned a unique ID and a promotion status indicator recorded for that transaction. Purchase date and price of the item may also be stored.

| UPC | Purchase Date | Household ID | Price | Promotion |
|---|---|---|---|---|
| 6379370730 | 02/01/2018 | 101 | 5.77 | 1 |

In one embodiment, before analyzing the cumulative transaction data as described herein, the collected transaction data may be filtered to remove customers who do not make a specified number of purchases in a specified time period. For example, the data may be filtered to remove “light users”, customers who fail to make more than 3 purchases of the item in a 52 week period. It will be appreciated that other purchase numbers and other time periods may also be specified in other embodiments.

Continuing with the description of FIG. 1, computing device 106 is in communication with server 104 and executes a loyalty determination module 108. The loyalty determination module determines an initial loyalty value, applies at least one promotion metric to the initial loyalty value and determines a promotion adjusted loyalty value. Computing device 106 and loyalty determination module 108 may communicate with computing device 120 executing inventory ordering module 122 when the adjusted loyalty value of an item meets a pre-determined threshold. When executed, inventory ordering module 122 may programmatically submit an order for one or more items to be delivered to the facility upon receiving notification from loyalty determination module 108 that the one or more items loyalty value's meet a pre-determined threshold. It will be appreciated that notwithstanding the adjusted loyalty value meeting the pre-determined threshold, the programmatic ordering of the item may also depend upon determination of a current amount of inventory in a facility. Although shown as separate devices and separate modules, it should be appreciated that in some embodiments the described functionality of server 104, computing devices 106 and 120 and loyalty determination module 108 and inventory ordering module 122 may be combined into fewer components or split into more components than depicted herein without departing from the scope of the present invention.

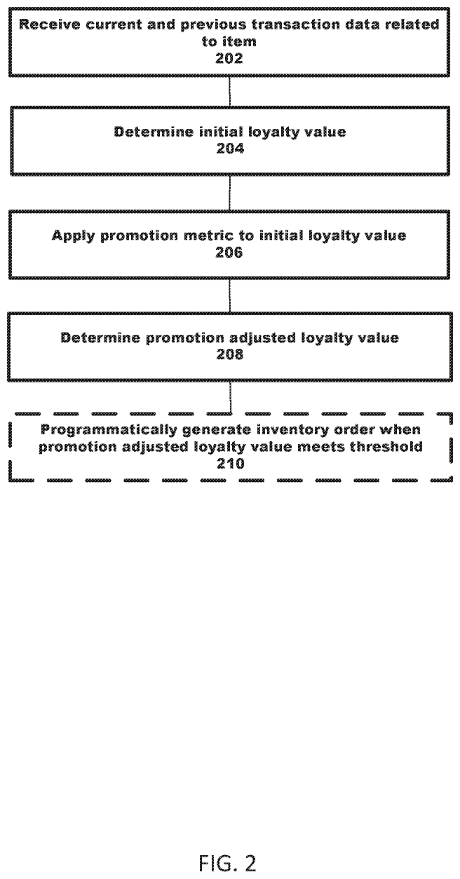

FIG. 2 is a high level flow diagram for a method of determining promotion adjusted loyalty, according to an example embodiment. The sequence begins with a computing device receiving and storing current transaction data and previous transaction data from at least one Point of Sale (PoS) terminal in a facility (step 202). The current transaction data is related to a current transaction in the facility that includes at least one item. The current transaction data is also associated with a customer and includes a promotional status for the at least one item during the current transaction. The previous transaction data relates to a previous transactions by the customer that are related to the at least one item and also includes a promotional status for the at least one item during each of the previous transactions. The previous transaction data may be limited to a specified time period. An initial loyalty value of the customer for the at least one item is determined using the stored current transaction data and previous transaction data (step 204). For example, the initial loyalty value of the customer/HH to an item may be made based on how often the customer/HH purchases the item when engaging in a transaction at the facility. At least one promotion metric is applied to the initial loyalty value (step 206) and a promotion adjusted loyalty value of the customer for the at least one item is generated based on the application (step 208). As discussed above, one promotion metric is based on a number of purchases of the item under promotion divided by a number of purchases of the item. In one example this metric may be determined according to the formula:

$$β ( j ) = \frac{Σ I ( T = j ⋂ P ( T ) = 1 )}{Σ I ( T = j )}$$

wherein β(i) is the promotion metric, and I is an indicator function. Another exemplary promotion metric is defined as a number of times a purchaser switched to the item due to a promotion divided by a total number of times the purchaser switched to the item. This metric may be determined according to the formula:

$$γ ( j ) = \frac{Σ I ( T = j ⋂ S ( T ) = 1 ⋂ Δ P ( T ) = 1 )}{Σ I ( T = i ⋂ S ( T ) = 1 )}$$

wherein Γ(i) is the promotion metric, and I is an indicator function. A further promotion metric may be defined as a number of times a purchaser bought the item after the promotion was discontinued divided by a total number of times the purchaser bought the item. As further detailed in processing block 326, in one example this metric is determined according to the formula:

$$ω ( i ) = \frac{Σ I ( T = i ⋂ S ( T ) = 0 ⋂ Δ P ( T ) = - 1 )}{Σ I ( T = i ⋂ S ( T ) = 0 )}$$

wherein ω(i) is the promotion metric, and I is an indicator function. An inventory order for the at least one item may be programmatically generated via an inventory ordering module based on the promotion adjusted loyalty value of the customer and promotion adjusted loyalty values of a plurality of other customers meeting a pre-defined threshold (step 210). The inventory ordering module programmatically submits an order for one or more items to be delivered to the facility. As noted above, the submission of the order is also dependent upon inventory constraints. For example, notwithstanding the promotion adjusted loyalty value meeting a pre-determined threshold, an order may not be submitted if an adequate supply of the item as tracked by the inventory ordering module already exists in the facility. In one embodiment, the inventory ordering module tracks inventory in a facility with the aid of one or more databases holding inventory data for one or more facilities.

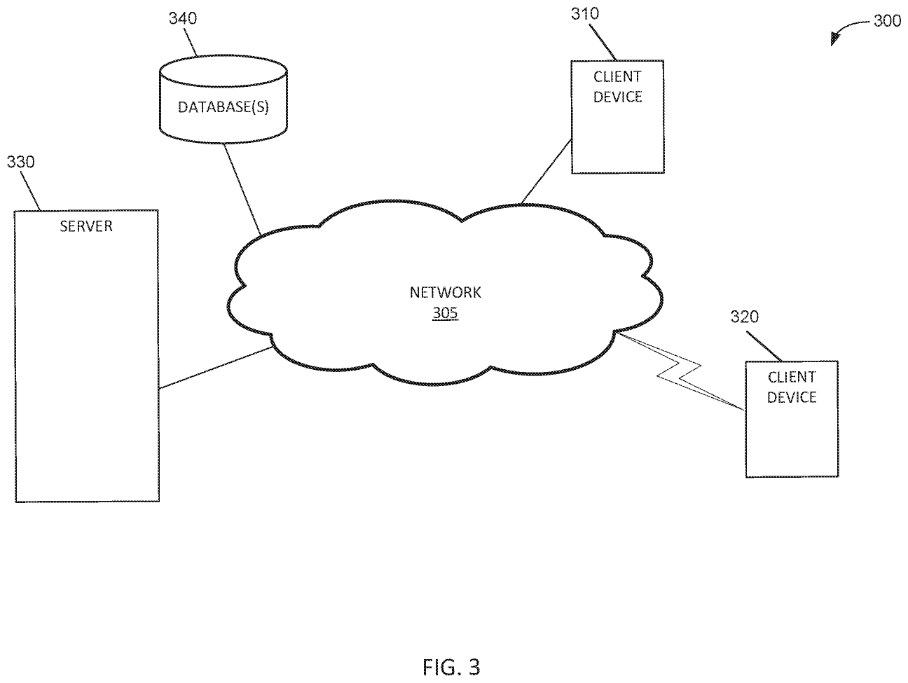

FIG. 3 illustrates a network diagram depicting a system 300 for determining promotion adjusted loyalty, according to an example embodiment. The system 300 can include a network 305, multiple client devices, for example, client device 310, client device 320, a server 330, and database(s) 340. Each of the client devices 310, 320, server 330, and database(s) 340 is in communication with the network 305.

In an example embodiment, one or more portions of network 305 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMAX network, another type of network, or a combination of two or more such networks.

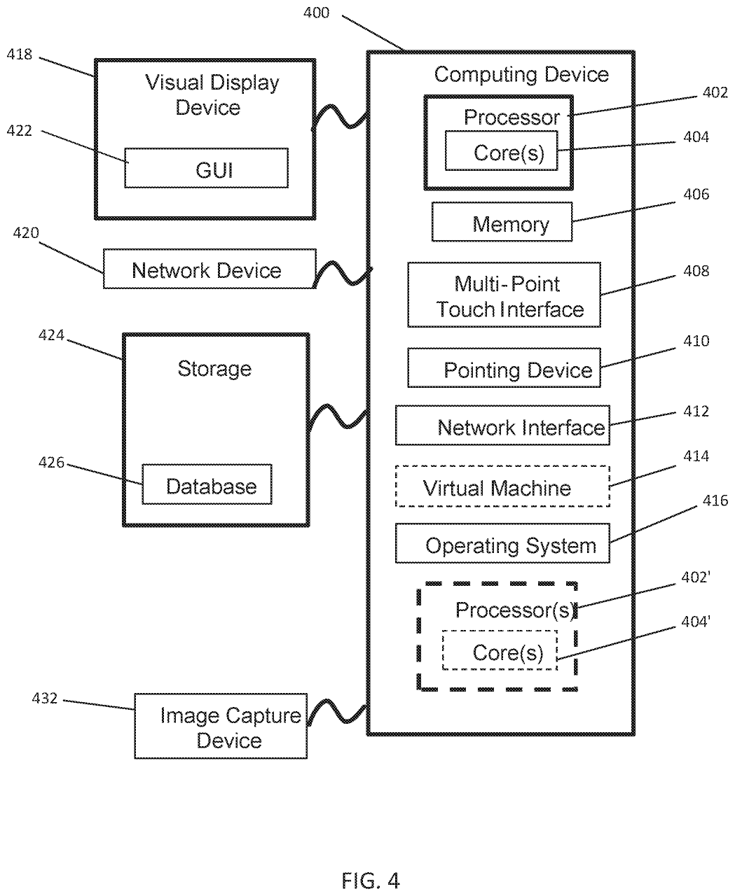

The client devices 310, 320 may comprise, but are not limited to, mobile devices, hand-held devices, wireless devices, portable devices, wearable computers, cellular or mobile phones, portable digital assistants (PDAs), smart phones, smart watches, tablets, ultrabooks, netbooks, laptops, desktops, multi-processor systems, microprocessor-based or programmable consumer electronics, and the like. Each of client devices 310, 320 may connect to network 305 via a wired or wireless connection. The client device 310, 320 can include one or more components of computing device 400 of FIG. 4.

In an example embodiment, the system 300 for determining promotion adjusted loyalty is included at least in part on the client device 310, 120, and the client device 310, 320 performs one or more of the functionalities of the system described herein. In an example embodiment, the system 300 may be included at least in part on the server 330, and the server 330 performs one or more of the functionalities of the system 300 described herein.

The database(s) 340 comprise one or more storage devices for storing data and/or instructions (or code) for use by the server 330 and/or the client devices 310, 320. Each of the database(s) 340 and the server 330 is connected to the network 305 via a wired or wireless connection. The server 330 includes one or more computers or processors configured to communicate with the client devices 310, 320 via network 305. The server 330 can include one or more components of computing device 400 of FIG. 4. Server 330 hosts one or more software systems, applications or websites, including one or more components of the system 300 described herein and/or facilitates access to the content of database(s) 340.

In an example embodiment, the server 330 also includes various software services that facilitate the functionalities of the system 300 for determining promotion adjusted loyalty. Database(s) 340 and server 330 may be located at one or more geographically distributed locations from each other or from client devices 310, 320. Alternatively, database(s) 340, 345 may be included within server 330.

FIG. 4 is a block diagram of an exemplary computing device 400 that can be used to perform one or more steps of the methods provided by exemplary embodiments. For example, computing device 400 may be the client device 310, 320 and the server 330 as described in FIG. 3. The computing device 400 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flash drives), and the like. For example, memory 406 included in the computing device 400 can store computer-readable and computer-executable instructions or software for implementing exemplary embodiments. The computing device 400 also includes processor 402 and associated core 404, and optionally, one or more additional processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ can each be a single core processor or multiple core (404 and 404′) processor.

Virtualization can be employed in the computing device 400 so that infrastructure and resources in the computing device can be shared dynamically. A virtual machine 414 can be provided to handle a process running on multiple processors so that the process appears to be using only one computing resource rather than multiple computing resources. Multiple virtual machines can also be used with one processor.

Memory 406 can include a computer system memory or random access memory, such as DRAM, SRAM, EDO RAM, and the like. Memory 506 can include other types of memory as well, or combinations thereof. An individual can interact with the computing device 400 through a visual display device 418, such as a touch screen display or computer monitor, which can display one or more user interfaces 422 for receiving data from the individual (e.g., order data and travel data). The visual display device 418 can also display other aspects, elements and/or information or data associated with exemplary embodiments. The computing device 400 can include other I/O devices for receiving input from an individual, for example, a keyboard or another suitable multi-point touch interface 408, a pointing device 410 (e.g., a pen, stylus, mouse, or trackpad). The keyboard 408 and the pointing device 410 can be coupled to the visual display device 418. The computing device 400 can include other suitable conventional I/O peripherals.

The computing device 400 can also include one or more storage devices 424, such as a hard-drive, CD-ROM, or other computer readable media, for storing data and computer-readable instructions and/or software, such as one or more modules of the system 100 shown in FIG. 1 that implements exemplary embodiments of the system as described herein, or portions thereof, which can be executed to generate user interface 422 on display 418. Exemplary storage device 424 can also store one or more databases for storing suitable information required to implement exemplary embodiments. The databases can be updated by an individual or automatically at a suitable time to add, delete or update one or more items in the databases. Exemplary storage device 424 can store one or more databases 426 for storing provisioned data, and other data/information used to implement exemplary embodiments of the systems and methods described herein.

The computing device 400 can include a network interface 412 configured to interface via one or more network devices 420 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 can include a built-in network adapter, network interface card, PCMCIA network card, card bus network adapter, wireless network adapter, USB network adapter, modem or another device suitable for interfacing the computing device 400 to a type of network capable of communication and performing the operations described herein. Moreover, the computing device 400 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 400 can run an operating system 416, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, an operating systems for mobile computing devices, or another operating system capable of running on the computing device and performing the operations described herein. In exemplary embodiments, the operating system 416 can be run in native mode or emulated mode. In an exemplary embodiment, the operating system 416 can be run on one or more cloud machine instances.

The description is presented to enable a person skilled in the art to create and use a computer system configuration and related method and systems for modifying capacity for a new retail facility. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts have been provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that the scope of protection sought herein should not be limited to the described embodiments but rather should be limited only by the spirit and scope of the following claims.

We claim:

1. A system for determining promotion adjusted loyalty, the system comprising:
at least one Point of Sale (PoS) terminal in a facility configured to process a current transaction that includes to at least one item, the processing generating transaction data, the transaction data associated with a customer and including a promotional status for the at least one item during the current transaction;
an inventory ordering module that when executed programmatically submits an order for one or more items to be delivered to the facility;
a server in communication with the at least one PoS terminal, the server configured to receive and store the current transaction data relating to the at least one item and previous transaction data received from the PoS terminal relating to a plurality of previous transactions by the customer that are related to the at least one item, the previous transaction data including a promotional status for the at least one item during each of the plurality of previous transactions; and
a computing device configured to execute a loyalty determination module, wherein the loyalty determination module, when executed:
determines an initial loyalty value of the customer for the at least one item using the stored current transaction data and previous transaction data;
generates a promotion adjusted loyalty value of the customer for the at least one item using the initial loyalty value and at least one promotion metric, and
programmatically generates an inventory order for the at least one item via the inventory ordering module based on the promotion adjusted loyalty value of the customer and promotion adjusted loyalty values of a plurality of other customers meeting a pre-defined threshold.

2. The system of claim 1, wherein the promotion metric includes a number of purchases of the item under promotion by the customer divided by a number of purchases of the item.

3. The system of claim 2, wherein the promotion metric is defined as:
$$β ( i ) = \frac{Σ I ( T = i \& P ( T ) = 1 )}{Σ I ( T = i )}$$
wherein β(i) is the promotion metric, and I is an indicator function defined by
$$I ( A ) = \{ \begin{matrix}1 , & A true \\ 0 & else\end{matrix}$$
and wherein a high promotion metric value indicates sales of the item are driven by the promotion, and lowers the resulting promotion adjusted loyalty value.

4. The system of claim 1, wherein the promotion metric includes a number of times the customer switched to the item due to a promotion divided by a number of times the customer switched to the item.

5. The system of claim 4, wherein the promotion metric is defined as:
$$γ ( i ) = \frac{Σ I ( T = i \& S ( T ) = 1 \& Δ P ( T ) = 1 )}{Σ I ( T = i \& S ( T ) = 1 )}$$
wherein γ(i) is the promotion metric, and I is an indicator function defined by
$$I ( A ) = \{ \begin{matrix}1 , & A true \\ 0 & else\end{matrix}$$
and wherein a high promotion metric value indicates sales of the item are driven by the promotion, and lowers the resulting promotion adjusted loyalty value.

6. The system of claim 1, wherein the promotion metric includes a number of times the customer bought the item after the promotion was discontinued divided by a number of times the customer bought the item.

7. The system of claim 6, wherein the promotion metric is defined as
$$ω ( i ) = \frac{\sum I ( T = i \& S ( T ) = 0 \& Δ P ( T ) = - 1 )}{\sum I ( T = i \& S ( T ) = 0 )}$$
wherein ω(i) is the promotion metric, and I is an indicator function defined by
$$I ( A ) = \{ \begin{matrix}1 , & A true \\ 0 & else\end{matrix}$$
and wherein a high promotion metric value indicates item loyalty and raises the resulting promotion adjusted loyalty value.

8. A computing device-implemented method for determining promotion adjusted loyalty, the computing device equipped with a processor, the method comprising:
receiving and storing current transaction data and previous transaction data from at least one Point of Sale (PoS) terminal in a facility, the current transaction data related to a current transaction in the facility that includes at least one item, the current transaction data associated with a customer and including a promotional status for the at least one item during the current transaction, the previous transaction data relating to a plurality of previous transactions by the customer that are related to the at least one item, the previous transaction data including a promotional status for the at least one item during each of the plurality of previous transactions;
determining an initial loyalty value of the customer for the at least one item using the stored current transaction data and previous transaction data;
generating a promotion adjusted loyalty value of the customer for the at least one item using the initial loyalty value and at least one promotion metric, and
generating programmatically an inventory order for the at least one item via an inventory ordering module based on the promotion adjusted loyalty value of the customer and promotion adjusted loyalty values of a plurality of other customers meeting a pre-defined threshold, the inventory ordering module programmatically submitting an order for one or more items to be delivered to the facility.

9. The method of claim 8, wherein the promotion metric includes a number of purchases of the item under promotion by the customer divided by a number of purchases of the item.

10. The method of claim 9, wherein the promotion metric is defined as
$$β ( i ) = \frac{\sum I ( T = i \& P ( T ) = 1 )}{\sum I ( T = i )}$$
wherein β(i) is the promotion metric, and I is an indicator function defined by
$$I ( A ) = \{ \begin{matrix}1 , & A true \\ 0 & else\end{matrix}$$
and wherein a high promotion metric value indicates sales of the item are driven by the promotion, and lowers the resulting promotion adjusted loyalty value.

11. The method of claim 8, wherein the promotion metric includes a number of times customer switched to the item due to a promotion divided by a number of times the customer switched to the item.

12. The method of claim 11, wherein the promotion metric is defined as
$$γ ( i ) = \frac{\sum I ( T = i \& S ( T ) = 1 \& Δ P ( T ) = 1 )}{\sum I ( T = i \& S ( T ) = 1 )}$$
wherein γ(i) is the promotion metric, and I is an indicator function defined by
$$I ( A ) = \{ \begin{matrix}1 , & A true \\ 0 & else\end{matrix}$$
wherein a high promotion metric value indicates sales of the item are driven by the promotion, and lowers the resulting promotion adjusted loyalty value.

13. The method of claim 8, wherein the promotion metric includes a number of times customer bought the item after a promotion was discontinued divided by a number of times the customer bought with the item.

14. The method of claim 13, wherein the promotion metric is defined as
$$ω ( i ) = \frac{\sum I ( T = i \& S ( T ) = 0 \& Δ P ( T ) = - 1 )}{\sum I ( T = i \& S ( T ) = 0 )}$$
wherein ω(i) is the promotion metric, and I is an indicator function defined by
$$I ( A ) = \{ \begin{matrix}1 , & A true \\ 0 & else\end{matrix}$$
wherein a high promotion metric value indicates item loyalty and raises the resulting promotion adjusted loyalty value.

15. A non-transitory machine-readable medium storing instructions for determining promotion adjusted loyalty, wherein execution of the instructions causes at least one computing device to:
receive and store current transaction data and previous transaction data from at least one Point of Sale (PoS) terminal in a facility, the current transaction data related to a current transaction in the facility that includes at least one item, the current transaction data associated with a customer and including a promotional status for the at least one item during the current transaction, the previous transaction data relating to a plurality of previous transactions by the customer that are related to the at least one item, the previous transaction data including a promotional status for the at least one item during each of the plurality of previous transactions;
determine an initial loyalty value of the customer for the at least one item using the stored current transaction data and previous transaction data;
generate a promotion adjusted loyalty value of the customer for the at least one item using the initial loyalty value and at least one promotion metric, and
generate programmatically an inventory order for the at least one item via an inventory ordering module based on the promotion adjusted loyalty value of the customer and promotion adjusted loyalty values of a plurality of other customers meeting a pre-defined threshold, the inventory ordering module programmatically submitting an order for one or more items to be delivered to the facility.

16. The medium of claim 15, wherein the promotion metric includes a number of purchases of the item under promotion by the customer divided by a number of purchases of the item.

17. The medium of claim 16, wherein the promotion metric is defined as
$$β ( i ) = \frac{\sum I ( T = i \& P ( T ) = 1 )}{\sum I ( T = i )}$$
wherein β(i) is the promotion metric, and I is an indicator function defined by
$$I ( A ) = \{ \begin{matrix}1 , & A true \\ 0 & else\end{matrix}$$
and wherein a high promotion metric value indicates sales of the item are driven by the promotion, and lowers the resulting promotion adjusted loyalty value.

18. The medium of claim 15, wherein the promotion metric includes a number of times customer switched to the item due to a promotion divided by a number of times the customer switched to the item.

19. The medium of claim 18, wherein the promotion metric is defined as
$$γ ( i ) = \frac{\sum I ( T = i \& S ( T ) = 1 \& Δ P ( T ) = 1 )}{\sum I ( T = i \& S ( T ) = 1 )}$$
wherein γ(i) is the promotion metric, and I is an indicator function defined by
$$I ( A ) = \{ \begin{matrix}1 , & A true \\ 0 & else\end{matrix}$$
wherein a high promotion metric value indicates sales of the item are driven by the promotion, and lowers the resulting promotion adjusted loyalty value.

20. The medium of claim 15, wherein the promotion metric includes a number of times customer bought the item after a promotion was discontinued divided by a number of times the customer bought with the item.

21. The medium of claim 20, wherein the promotion metric is defined as
$$ω ( i ) = \frac{\sum I ( T = i \& S ( T ) = 0 \& Δ P ( T ) = - 1 )}{\sum I ( T = i \& S ( T ) = 0 )}$$
wherein ω(i) is the promotion metric, and I is an indicator function defined by
$$I ( A ) = \{ \begin{matrix}1 , & A true \\ 0 & else\end{matrix}$$
wherein a high promotion metric value indicates item loyalty and raises the resulting promotion adjusted loyalty value.
